(19) United States
(12) Patent Application Publication
(10) Pub. No.: US 2011/0061048 A1
(43) Pub. Date: Mar. 10, 2011

(54) IMAGE FORMING DEVICE, INSTALLING METHOD, AND RECORDING MEDIUM

(75) Inventor: Katsuhiko KATOH, Kanagawa (JP)

(73) Assignee: RICOH COMPANY, LTD.

(21) Appl. No.: 12/871,011

(22) Filed: Aug. 30, 2010

(30) Foreign Application Priority Data
Sep. 9, 2009 (JP) 2009-208463

(51) Int. Cl. G06F 9/445

(52) U.S. Cl. 717/177

(57) ABSTRACT

An image forming device includes an information acquisition unit which acquires information of an execution environment of the image forming device. A program identifying unit identifies a first program which is executable in the execution environment of the image forming device, based on the acquired information of the execution environment. A copy unit copies the identified first program and a second program of a program package to a storage unit of the image forming device. The information acquisition unit, the program identifying unit, and the copy unit are installed in the image forming device by executing a program for installation of the program package.

### BACKGROUND OF THE INVENTION

1. Field of the Invention

The present disclosure relates to an image forming device, an installing method, and a recording medium which are adapted to install a program in the image forming device.

2. Description of the Related Art

In image forming devices, including single-function image forming devices having one of a print function, a scanner function, a copy function, etc., and MFP (multi-function peripherals) having the multiple functions, application programs corresponding to the respective functions or subdivided functions thereof are installed. In a control system of an image forming device, an API (application programming interface) for utilizing an MFP to enable easier operation is prepared. A software developer (third party) or a user may develop an application program which utilizes any of the scanner function, the print function, the copy function, etc. by using an SDK (software development kit) provided by the image-forming-device manufacturer, and may create a value-added function based on the function provided by the image-forming-device manufacturer.

An application program of certain type (for example, a Java (registered trademark) program) can be executed independently of the hardware or the software, and use of the application program will increase the range of use of an image forming device. Usually, there are image forming devices of different models, image forming devices of the succeeding models of one model, etc. Development of the application program that can be executed independently of the hardware or the software will be of great merit.

On the other hand, execution of the application program of the above type requires formation of a virtual machine on the hardware, and it is necessary to take into consideration the compatibility of the virtual machine with the hardware. For example, Japanese Laid-Open Patent Publication No. 2006-148865 discloses the technology of checking hardware information of an image forming device when installing a program in the image forming device, and selecting a program for installation based on the hardware information.

However, the technology of Japanese Laid-Open Patent Publication No. 2006-148865 is directed to performing upgrading of a virtual machine by eliminating the hardware dependency and does not take into consideration the installation of an application program the development of which is difficult using the programming language which does not depend on the hardware or the software.

Generally, in the case of the API for the SDK, the API of the function which is supplied to the software developer or the user for development purposes by the image-forming-device manufacturer is restricted. For this reason, an application program of a desired function may not be developed by using only the API available to the software developer or the user. In many cases, the image-forming-device manufacturer performs customized development which modifies the software of the main part of an MFP for each of individual users.

In order to perform the customized development for each user, the development of the software of functions that are not planned originally must be performed by the image-forming-device manufacturer, and the manpower and cost will be increased. The source codes will become complicated as a result of the customized development, and it is difficult to manage the source code.

In order to eliminate the problem, it is necessary that the image-forming-device manufacturer provide the software developer or the user with the API or the mechanism which enables the software developer or the user to use all the functions of the image forming device, including the stopping or deletion of a specific function of the image forming device. To provide the API or the mechanism, the development of a program which operates on a virtual machine is useful as described above.

However, the image forming device, such as an MFP, performs the control of the hardware, such as a scanner or a plotter, and may incorporate a printer function controlled by a sophisticated procedure that should be protected from a competitor manufacturer. It is impossible to develop all the application programs for the functions of the image forming device by the programming language which causes the programs to operate on a virtual machine on the hardware. An application program for a function which significantly affects the performance of the product must be developed in the programming language, such as C. In the case of the program developed by the programming language C, the binary codes obtained as a result of compiling the program differ if the CPU (and the platform containing the software) differs. In this case, it is necessary to develop a different program for each product.

It is desirable for the image-forming-device manufacturer that a plug-in program which has been marketed at a certain time operates normally on another product marketed at another time. The user does not desire to purchase a different plug-in for each product, and the management of plug-in programs on the manufacturer side becomes complicated if different plug-in programs for a same function are marketed for each model.

However, if the program for the function which significantly affects the performance of the product is developed without using the programming language C, a problem may arise in which the fundamental performance of the product cannot be attained. The hardware and the software incorporated in the products differ if the products are of different versions. A problem may arise in which the manufacturer must provide the software developer or the user with the API or the mechanism which enables the software developer or the user to use all the functions of the image forming device. Another problem may arise in which a plug-in program having been developed for the product of old version does not operate normally on the product of new version. For this reason, the image-forming-device manufacturer currently has the problem that a different plug-in of a same function must be marketed for each product.

### SUMMARY OF THE INVENTION

In one aspect, the present disclosure provides an image forming device, an installing method, and a recording medium which are capable of supplying a common package of plug-in programs allowing two or more products to operate normally by making use of application programs that are not dependent on the hardware or the software, even when the products are of different models or of different versions.

In an embodiment of the invention which solves or reduces one or more of the above-mentioned problems, the present disclosure provides an image forming device including a processor unit including: a package acquisition unit to acquire a program package through a recording medium or a network, the program package containing a program for installation, a first program and a second program, the program for installation described in a system-independent programming language that is executable without depending on execution environments, the first program described in a system-dependent programming language that is executed depending on a particular execution environment and registered for the particular execution environment, and the second program described in a system-independent programming language that is executable without depending on execution environments and registered commonly for execution environments; an information acquisition unit to acquire information of an execution environment of the image forming device; a program identifying unit to identify the first program which is executable in the execution environment of the image forming device, based on the information of the execution environment acquired by the information acquisition unit; and a copy unit to copy the first program, identified by the program identifying unit, and the second program to a storage unit of the image forming device, wherein the information acquisition unit, the program identifying unit, and the copy unit are installed in the image forming device by executing the program for installation.

Other objects, features and advantages of the present disclosure will become more apparent from the following detailed description when read in conjunction with the accompanying drawings.

### BRIEF DESCRIPTION OF THE DRAWINGS

FIG. 1 is a diagram illustrating the hardware composition of an image forming device of an embodiment of the present disclosure.

FIG. 2 is a diagram illustrating the software composition of the image forming device of this embodiment.

FIG. 3 is a diagram for explaining the mode of installation.

FIG. 4 is a diagram illustrating an example of hardware information and software information of image forming devices.

FIG. 5 is a diagram illustrating the functional composition of an installation unit of the image forming device of this embodiment.

FIG. 6 is a diagram for explaining the contents of a functional update package.

FIG. 7 is a diagram for explaining an association file.

FIG. 8 is a diagram for explaining a tree structure of directories of a sales package.

FIG. 9 is a flowchart for explaining the installing procedure performed by the installation unit to install a functional update package in the image forming device of this embodiment.

FIG. 10 is a diagram illustrating an example of a sales package which can be installed in both a previously marketed image forming device and a currently marketed image forming device.

### DETAILED DESCRIPTION OF THE PREFERRED EMBODIMENTS

A description will be given of embodiments of the present disclosure with reference to the accompanying drawings.

A sales package and an installing method which are installed in an image forming device 100 of an embodiment of the present disclosure will be described.

In the sales package, a common program which operates on a virtual machine (such as Java virtual machine) and is common to all the models, and a binary program (native program) which depends on the hardware and the software, such as the OS, are included. Examples of the native program include a binary program which can be executed on a product of a previous model which is commercially produced when the sales package is marketed by the image-forming-device manufacturer.

When the sales package is installed, each image forming device 100 accesses hardware information and software information of the image forming device, and the information of the native program included in the sales package, and a native program suitable for the hardware of the image forming device and the common program can be stored in a storage location where the program for the function is to be stored.

Several native programs for different models may be contained in a sales package, and a program which is developed subsequently after the time of marketing of a certain product may be contained in a single sales package that is applicable to all the models, and the sales package can be marketed.

The composition of an image forming device 100 of an embodiment of the present disclosure will be described. This image forming device 100 is an example of the installation object of a sales package. If this image forming device 100 is provided with a computer, the sales package of this embodiment is applicable to the image forming device 100.

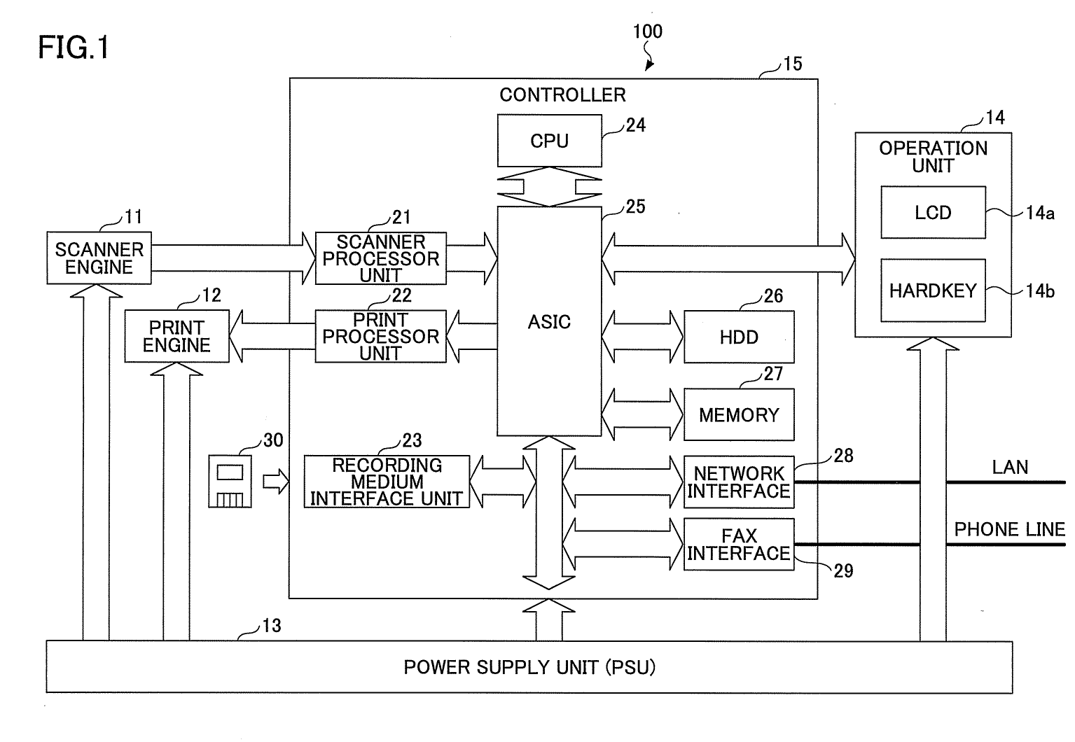

FIG. 1 is a diagram illustrating the hardware composition of the image forming device 100. The image forming device 100 is, for example, an MFP (multi-function peripheral) which has multiple image forming functions, including a print function, a facsimile function, a copy function, and a scanner function.

In the following, the MFP is illustrated as an exemplary image forming device 100 according to the present disclosure.

As illustrated in FIG. 1, the image forming device 100 includes a controller 15, a scanner engine 11, a print engine 12, a PSU (power supply unit) 13, and an operation unit 14. The controller 15 includes a CPU 24, an ASIC (application-specific integrated circuit) 25, a scanner processor unit 21, a print processor unit 22, a recording medium interface unit 23, a HDD (hard disk drive) 26, a memory 27, a network interface 28, and a fax interface 29, which are interconnected by a bus.

The operation unit 14 includes a LCD (liquid crystal display) 14a and a set of hard keys 14b. The LCD 14a is arranged with a built-in touch panel and provides a function of displaying various types of screens, and a function of receiving an input operation from an operator who transmits various types of transmission data from the image forming device 100. The hard keys 14b include ten keys, a start button, a reset button, an application change button, etc.

The scanner engine 11 is a reading unit which reads an original document optically. For example, the scanner engine 11 include a contact glass, a light source, a lens system, and an image sensor. The scanner engine 11 is connected to the scanner processor unit 21. The scanner processor unit 21 performs A/D (analog-to-digital) conversion of an electrical charge accumulated in the image sensor to generate digital data with a predetermined gradation.

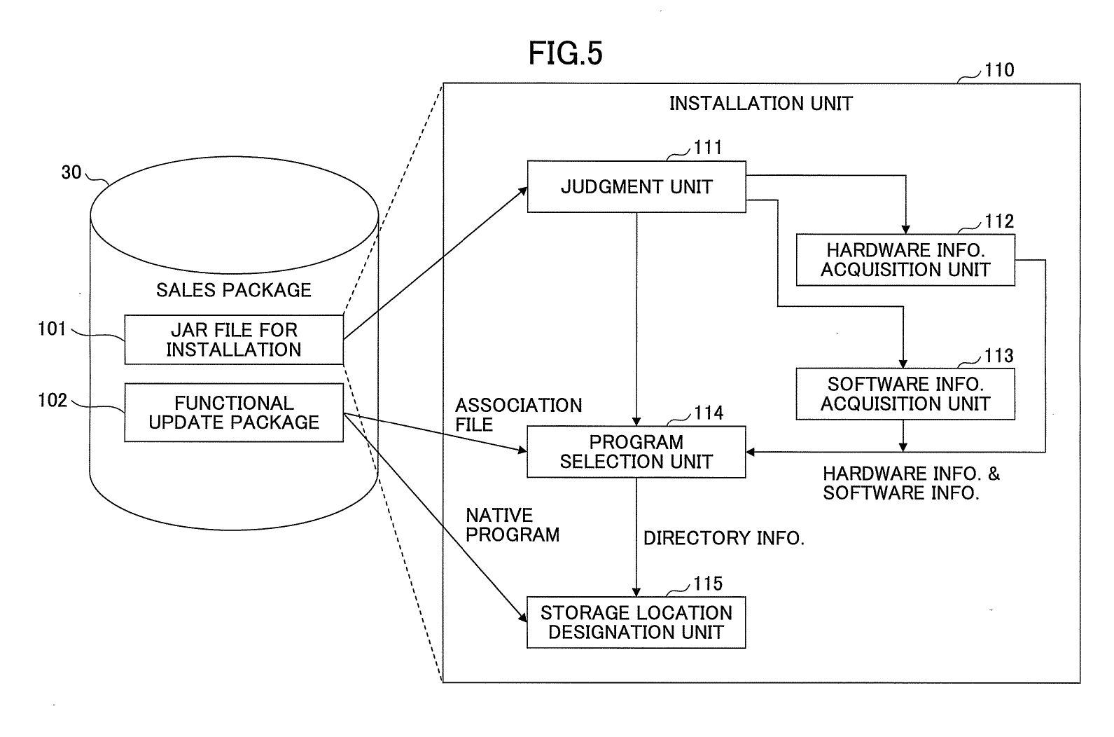

The print engine 12 provides a function of printing an image on a copy sheet. The print engine 12 includes a photoconductor drum, a charging unit, a developing unit, a laser irradiation unit, a fixing unit, a sheet transport unit, etc. The print engine 12 is connected to the print processor unit 22. The print processor unit 22 converts image data generated by the scanner processor unit 21, into raster data, and converts print data received from a PC 500 (see FIG. 5), into raster data, and transmits the raster data to the print engine 12. In this manner, the print engine 12 provides the function of printing an image on a copy sheet.

The CPU 24 controls the whole image forming device 100 in a centralized manner. The ASIC 25 is an IC (integrated circuit) for image-processing purpose which provides various types of image processing necessary for the scanner process or the printing process.

The memory 27 stores various application programs which are executed by the CPU 24, and various data which are used when a corresponding application program is executed.

The HDD 26 is a non-volatile memory which stores image data, programs, font data, etc. An SSD (solid state drive) may be implemented in a part of the HDD 26 or the whole HDD 26. The CPU 24 executes the program stored in the HDD 26 or the program included in the sales package, and provides a corresponding one of the respective functions which will be described later.

A sales package is stored in a recording medium 30 and the recording medium 30 with the sales package stored therein is distributed. When the recording medium 30 is inserted into the slot of the recording medium interface unit 23, the sales package may be read from the recording medium 30 by the recording medium interface unit 23 and may be installed in the HDD 26. Alternatively, the sales package which is received from a server 300 via the network interface 28 may be installed in the HDD 26.

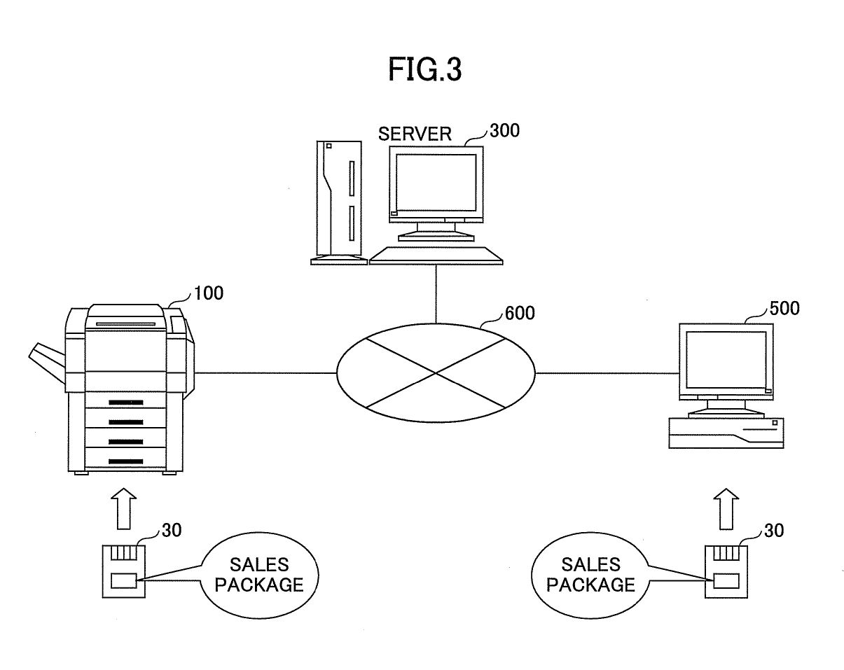

The network interface 28 is connected to a network 600 (see FIG. 3). For example, the network interface 28 is a NIC (network interface card) and provides a function of performing telecommunications between the image forming device 100 and the server 300 or the PC 500 via the network 600 in accordance with a predetermined protocol.

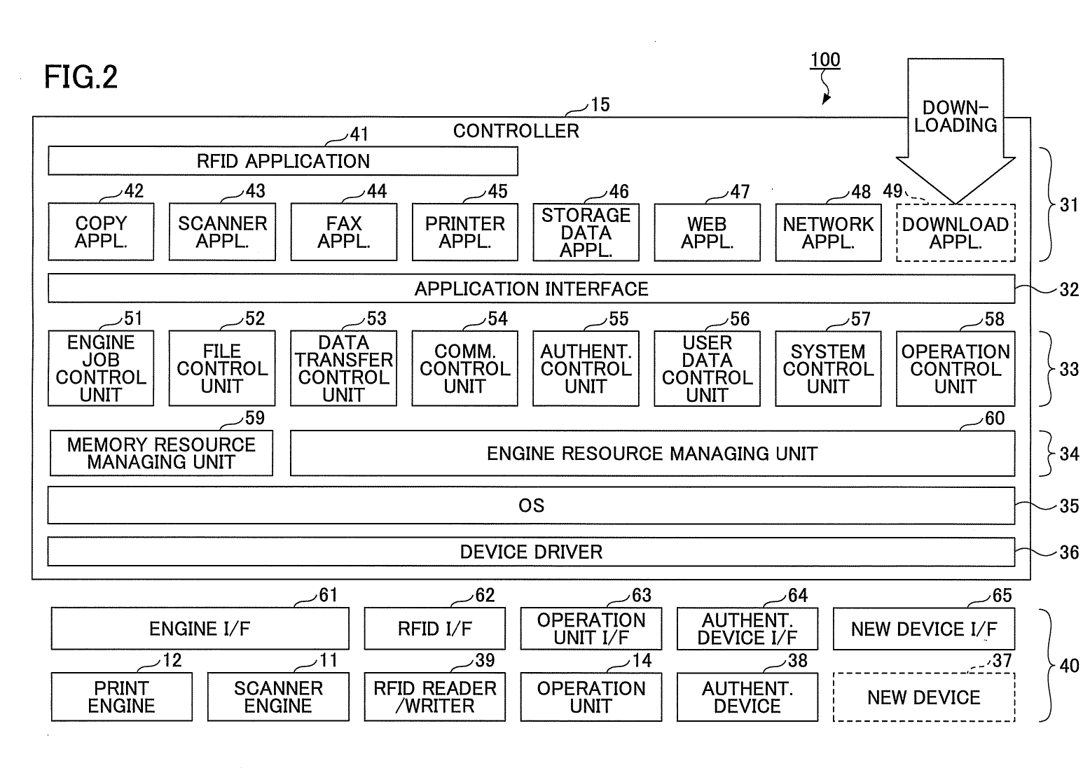

The fax interface 29 is connected to the telephone line. The fax interface 29 demodulates the facsimile data received from the telephone line, and generates image data. When a fax application 44 (see FIG. 2) is started, the fax interface 29 converts the image data read by the scanner engine 11, into facsimile data, modulates the facsimile data, and outputs the facsimile data to the telephone line.

The PSU 13 controls supply of the power to the controller 15, the operation unit 14, the scanner engine 11, and the print engine 12.

FIG. 2 is a diagram illustrating the software composition of the image forming device 100.

As illustrated in FIG. 2, the image forming device 100 includes an application group 31, an application interface 32, a control function group 33, a resource managing unit 34, an OS 35, a device driver 36, and hardware resources 40.

The application group 31 includes an RFID (radio frequency identification) application 41, a copy application 42, a scanner application 43, a fax application 44, a print application 45, an accumulation data application 46, a Web application 47, a network application 48, and a download application 49. Each of these applications provides a corresponding one of the various functions of the MFP.

The accumulation data application 46 provides functions of viewing and selecting the image data or print data accumulated in the HDD 26. The Web application 47 provides a browser function of accessing a Web server and displaying various types of information stored in the Web server on the LCD 14a. The network application 48 provides a communication function which enables the image forming device 100 to communicate with the Web server and the PC 500 via the network 600.

The download application 49 is an application program which is downloaded from the Web server or the PC 500 as an extended function of the MFP. The RFID application 41 provides functions of reading information from an IC card and identifying an operator who owns the IC card.

The control function group 33 includes an engine job control unit 51, a file control unit 52, a data transfer control unit 53, a communication control unit 54, an authentication control unit 55, a user data control unit 56, a system control unit 57, and an operation control unit 58.

The engine job control unit 51 controls the print engine 12 or the scanner engine 11 which is connected via the engine interface 61. The file control unit 52 controls updating, deletion and movement of various types of files which are stored in the HDD 26.

The data transfer control unit 53 controls data transfer of the document data accumulated in the HDD 26. The communication control unit 54 controls communication through the network interface 28. The authentication control unit 55 controls the authentication device 38 via the authentication device interface 64.

The user data control unit 56 manages user information. The system control unit 57 performs processing for controlling the system. The operation control unit 58 controls the operation unit 14 which provides an information transfer interface between an operator and the controller 15.

The memory resource managing unit 59 monitors the operating condition of the memory 27, and performs freeing or allocating of the memory 27. The engine resource managing unit 60 performs the system control and management of the hardware resources 40.

The application group 31 requests the control function group 33 through the application interface 32 to provide a function of the control function group 33. The control function group 33 interprets a processing request sent from the application group 31, and generates an acquisition request of the hardware resources 40. The memory resource managing unit 59 or the engine resource managing unit 60 arbitrates acquisition requests from the control function group 33. The OS 35 (for example, LINUX (registered trademark)) performs parallel execution of processes by the respective programs of the application group 31, the control function group 33, and the resource managing unit 34.

The device driver 36 sends a processing request to the hardware resources 40 by using any of an engine interface 61, an RFID interface 62, an operation unit interface 63, an authentication device interface 64, and a new device interface 65. The RFID reader/writer 39 reads out the identification information from an IC card when the IC card is made to contact the reader/writer 39 or placed over the reader/writer 39 in a non-contact manner. The authentication device 38 may be arranged to acquire a password input from the hard keys 14b or biometric information from the user. The new device interface 65 may be a USB interface device which allows a new device 37 having a USB interface to be connected thereto and makes use of the function of the new device 37. The image forming device 100 carries out the common processes required by the application programs in a unitary manner by executing the processes of the control function group 33.

For example, a common program containing the application group 31, and a native program containing the control function group 33, the device driver 36 and others, may be included in a sales package, and the common program and the native program may be respectively provided by using the sales package.

FIG. 3 is a diagram for explaining the mode of installation. The image forming device 100 with a recording medium 30, and the PC (personal computer) 500 with a recording medium 30 are illustrated.

The image forming device 100, the PC 500, and the server 300 are connected together via the network 600. The mode of installation of this embodiment may be one of the following modes.
(1) The mode in which a user attaches the recording medium 30 to the image forming device 100 and the image forming device 100 installs a program from the recording medium 30 in the image forming device 100.
(2) The mode in which a user attaches the recording medium 30 to the PC 500 and the PC 500 installs a program from the recording medium 30 in the image forming device 100 via the network 600.
(3) The mode in which the image forming device 100 downloads a sales package from the server 300 and the image forming device 100 installs a program from the sale package in the image forming device 100.

Therefore, the sales package is distributed through the recording medium 30 in which the sales package is stored or through the network 600 in which the sales package is downloaded from the server 300.

In the modes of (1) and (3) above, the image forming device 100 executes a jar file 101 for installation from the sales package, and in the mode of (2) above, the PC 500 executes the jar file 101 for installation from the sales package.

In the following, it is assumed that the sales package of this embodiment is installed in the mode of (1) or (3) above. Alternatively, the sales package of this embodiment may be installed in the mode of (2) above in a similar manner.

Next, image forming devices, which are the target of the sales package according to the present disclosure, and hardware information and software information of the image forming devices will be explained.

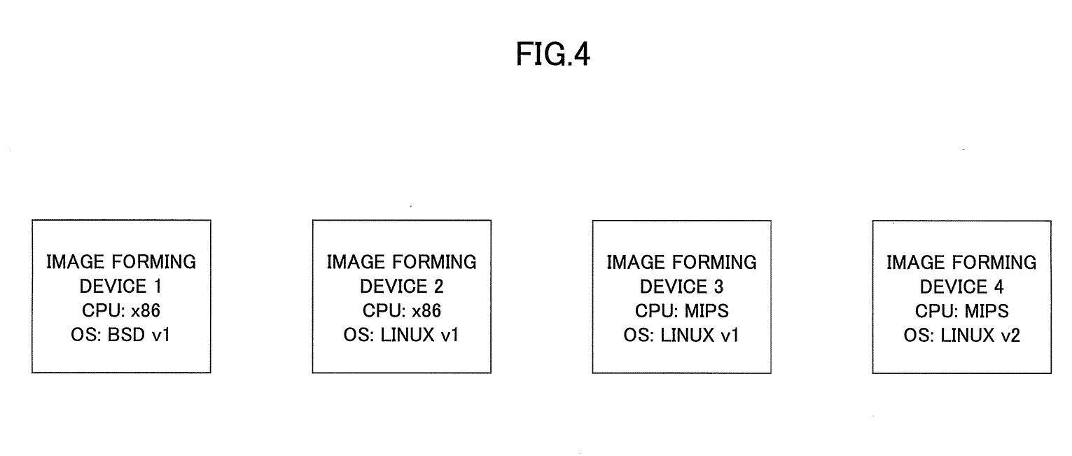

FIG. 4 illustrates an example of hardware information and software information of image forming devices 1 to 4 which are the target of the sales package according to the present disclosure.

The hardware information contains any of a CPU type, a CPU name, a CPU model number, a CPU model name, etc. The software information contains any of an OS type, an OS version, a version of a DLL (dynamic link library), etc.

It is assumed that the times of sale of the image forming devices 1-4 are different from each other. As illustrated in FIG. 4, the image forming device 1 incorporates a CPU 24 of the x86 architecture and incorporates an OS of BSD (Berkeley Software Distribution) version 1. The image forming device 2 incorporates a CPU 24 of x86 architecture and incorporates an OS of LINUX version 1. The image forming device 3 incorporates a CPU 24 of MIPS architecture and incorporates an OS of LINUX version 1. The image forming device 4 incorporates a CPU 24 of MIPS architecture and incorporates an OS of LINUX version 2.

Because the times of sale of these products are different, the architecture of the CPU 24 of each product and the type and version of the OS of each product are also different. It is common that the image forming device 100 which is actually installed in the premises of a user or customer incorporate a product the time of sale of which is different in this way.

For example, it is assumed that the user has purchased the latest type image forming device 4 recently, and at the time of purchase of the image forming device 4, the user has purchased a sales package concurrently. This sales package provides a function essential to the needs of the user.

In this case, if the image forming devices 1, 2, and 3 are still marketed, the same sales package may be on sale. However, if the image forming device 4 is a next-generation machine of the image forming device 3, it is usually difficult to purchase the sales package for the image forming device 3 at the time of purchase of the image forming device 4. Even if the sales package for the image forming device 3 is on sale, it is common that the sales package for the image forming device 3 and the sales package for the image forming device 4 are marketed separately.

To eliminate the problem, the sales package according to the present disclosure provides a single sales package which is common to all of the image forming devices 1-4 and can be installed in any of the image forming devices 1-3.

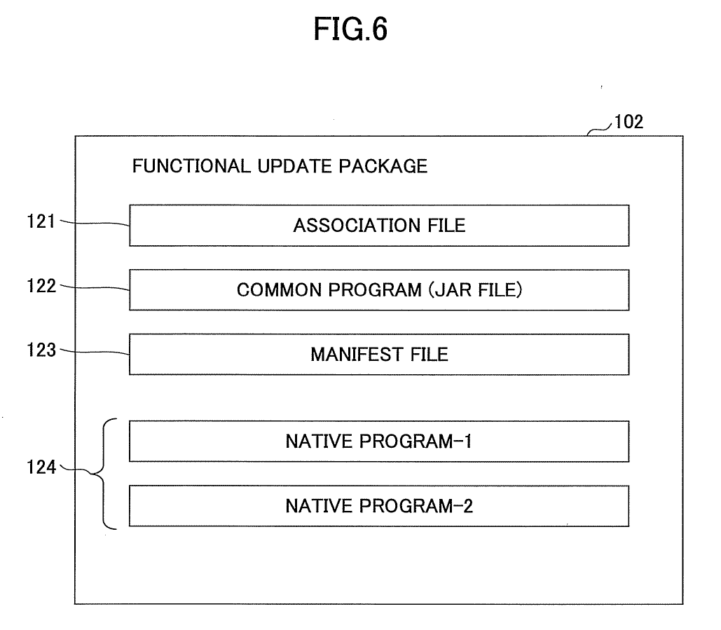

FIG. 5 illustrates the functional composition of an installation unit 110 of the image forming device 100 of this embodiment. FIG. 6 is a diagram for explaining the contents of a functional update package 102 of a sales package.

The sales package in the recoding medium 30 contains a jar file 101 for installation and a functional update package 102. The functional update package 102 contains an association file 121, a common program (jar file) 122, a manifesto file 123, a native program-1 124, and a native program-2 124.

The CPU 24 of the image forming device 100 reads the jar file 101 for installation directly from the recording medium 30 or from the sales package stored the HDD of the image forming device 100, and performs the jar file 101 for installation. Execution of the jar file 101 for installation by the CPU 24 of the image forming device 100 causes the CPU 24 to install the installation unit 110 in the image forming device 100. The installation unit 110 includes a judgment unit 111, a hardware information acquisition unit 112, a software information acquisition unit 113, a program selection unit 114, and a storage location designation unit 115.

The installation unit 110 may be configured to display a message indicating that installation of a program is under execution, on the operation unit 14 of the image forming device 100 or a display device of the PC 500 which is connected to the image forming device 10 via the network 600 by the USB connection.

The installation unit 110 may be configured to display a message indicating that addition of a function which needs to acquire hardware information is under execution, or a message indicating that addition of a function which needs to acquire software information is under execution, on the operation unit 14 or the display device.

Alternatively, instead of the jar file 101 for installation being included in the sales package, the jar file 101 for installation may be stored beforehand in the image forming device 100. Alternatively, the jar file 101 for installation and the functional update package 102 may be distributed separately. Because a new function cannot be added to the image forming device 100 with the jar file 101 for installation only, there is no need to charge the user for the jar file 101 for installation. If downloading of the jar file 101 for installation from the server 300 is allowed at no charge, the user can always use the jar file 101 for installation of the latest version.

First, the judgment unit 111 of the installation unit 110 will be described. The jar file 101 for installation is described in a system-independent programming language (for example, Java or C#) which is executable without depending on the hardware platform or the software platform (or which is executable if a Java virtual machine can operate). In this embodiment, the jar file 101 for installation and the common program (jar file) 122 are examples of programs described in a system-independent programming language that is not dependent on the platform or the execution environment.

The judgment unit 111 determines whether there is a need to check the software information, and determines whether there is a need to check the hardware information. The jar file 101 for installation is a file which is generated as a result of compiling of a program described in a system-independent programming language. With the jar file 101 for installation, the virtual machine can operate without depending on the hardware platform or the software platform.

The reason the judgment unit 111 is described by the jar file 101 for installation is as follows. If the program corresponding to the judgment unit 111 is described in a system-dependent programming language (which is executed depending on a particular platform), the program corresponding to the judgment unit 111 may be executed by the CPU 24 on the platform of the image forming device of a certain model, but cannot be executed by the CPU 24 on the platform of the image forming device of another model. To avoid the problem, it is preferred that the jar file 101 for installation, including the judgment unit 111, is described in a system-independent programming language that is executable without depending on execution environments.

The judgment unit 111 described in a system-dependent programming language (for example, a native program) may be installed in the image forming device 100. However, in such a case, it will be difficult to take corrective measures for various kinds of hardware information and software information which will be present in the future.

In this embodiment, the jar file 101 for installation is described in the system-independent programming language. When the jar file 101 for installation which is stored beforehand in the image forming device 100 needs to be rewritten temporarily, the jar file 101 for installation may be easily updated. Accordingly, the image-forming-device manufacturer can market a single sales package that is applicable to all the models.

The judgment unit 111 determines whether there is a need to acquire the hardware information. When the acquisition of the hardware information is needed, the judgment unit 111 sends a request of acquisition of hardware information to the hardware information acquisition unit 112.

Similarly, the judgment unit 111 determines whether there is a need to acquire the software information. When the acquisition of the software information is needed, the judgment unit 111 sends a request of acquisition of software information to the software information acquisition unit 113.

The jar file 101 for installation contains a type of the sales package. For example, the type of the sales package may be described as “native program upgrade package”. The type of the sales package may be described as “native”, which indicates that the native program 124 is included in the sales package. The type of the sales package may be described as “accessing hardware information and accessing software information are needed”. Alternatively, a number, a keyword, etc. may be used to indicate the type of the sales package with such meanings.

It is desirable that the jar file 101 for installation contains information indicating whether accessing hardware information and accessing software information are required. For example, in a case of a sales package which does not require accessing hardware information, the jar file 101 for installation contains information indicating that accessing hardware information is not required.

However, it is not necessary for the jar file 101 for installation to contain the information of whether accessing software information and hardware information is needed. Alternatively, another separate file which contains the information of whether accessing software information and hardware information is needed may be included in the sales package.

Next, the hardware information acquisition unit 112 of the installation unit 110 will be described.

The hardware information acquisition unit 112 acquires the hardware information from the image forming device 100 and transfers the hardware information to the program selection unit 114. Specifically, when the native program 124 exists among the programs of the functional update package 102 to be added, the hardware information acquisition unit 112 acquires the hardware information.

The hardware information which is acquired by the hardware information acquisition unit 112 in this case is fundamentally a CPU type.

In addition, when hardware that is dependent on the hardware information is contained in the contents of the functional update package 102, the hardware information acquisition unit 112 acquires the information of the dependent hardware (for example, a DSP (digital signal processor)).

Next, the software information acquisition unit 113 of the installation unit 110 will be described.

The software information acquisition unit 113 acquires the software information from the image forming device 100 and transfers the software information to the program selection unit 114. Specifically, when the native program 124 exists among the programs of the functional update package to be added and the product with an OS different from the OS of the previously marketed product is marketed, it is for the software information acquisition unit 113 to acquire the software information. When the OS of the same type is upgraded but the interface of system calls remains unchanged, the acquisition of the software information is unnecessary. When an OS of a different type and different system calls are added by updating, the acquisition of the software information is needed. Examples of the software information may include an OS version and a version of a library file, such as DLL.

Next, the program selection unit 114 of the installation unit 110 will be described.

The program selection unit 114 accesses the association file 121 or the manifesto file 123 included in the functional update package 102, based on the hardware information obtained from the hardware information acquisition unit 112 and the software information obtained from the software information acquisition unit 113, and selects a storage location (directory information) of the functional update package at which the native program 124 to be installed in the product is stored, based on the association file 121 or the manifesto file 123.

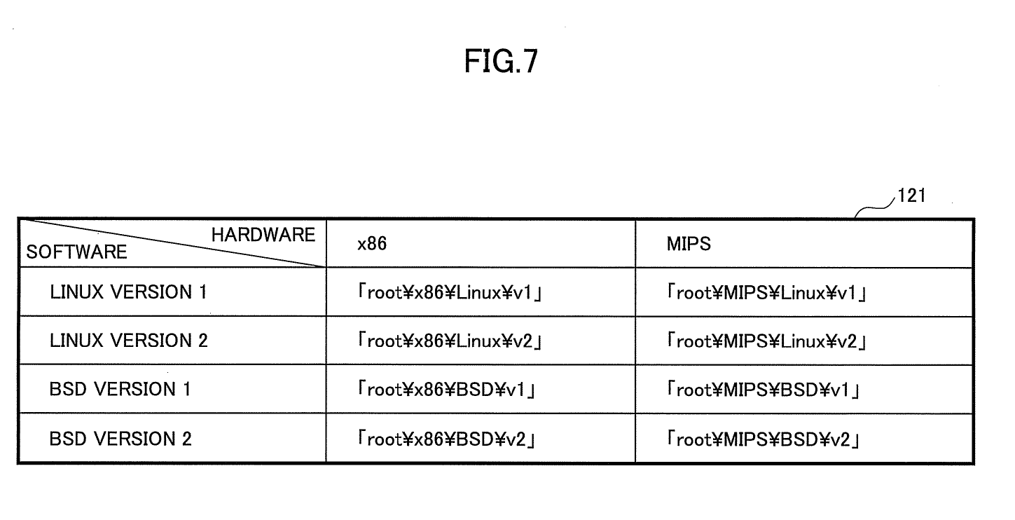

FIG. 7 is a diagram for explaining the association file 121. In the association file 121, a native program 124 to be installed is associated with the hardware information and the software information and stored therein with the association.

The program selection unit 114 transfers the directory information selected based on the association file 121, to the storage location designation unit 115. The association file 121 may be included in the manifesto file 123. In this case, the association file 121 is replaced with the manifesto file 123.

As illustrated in FIG. 5, the storage location designation unit 115 reads out the native program 124 stored at the storage location based on the directory information received from the program selection unit 114. The storage location designation unit 115 copies the native program 124 to the storage location of the image forming device 100 at which the native program 124 is to be stored.

Subsequently, the storage location designation unit 115 installs the common program (jar file) 122 at the storage location of the image forming device 100. The common program (jar file) 122 is prepared as a function, and the installation of the common program (jar file) 122 allows the additional function to be used.

The reason the storage locations of two or more native programs 124 are different for each storage location is as follows. The requirement in Java that a class name and a file name must be in agreement is taken into consideration. A method call of a program described in Java is performed by a class name. When the names of the native programs 124, the contents of which are different due to the hardware or software dependency are managed by separate names, it is necessary that the common program (jar file) 122 designate one of the native programs 124 by accessing the hardware information and the software information of each image forming device 100.

In such a case, the advantageous features by adopting the system-independent programming language in this embodiment are lost. Each time a new product is marketed, modifications to the common program (jar file) 122 must be made. To eliminate the problem, even if the hardware and software environment differ, the names of the native programs 124 are the same name, and the storage locations of the native programs 124 within the functional update package of the sales package are different.

The directory (the storage location) of the native program 124 is common to each image forming device 100, and this makes it possible to reduce the management complexity and excessive development activities.

Because the files with a same file name cannot be stored in the same directory, the native programs 124 with the same file name are individually stored (registered) at different directories (different storage locations).

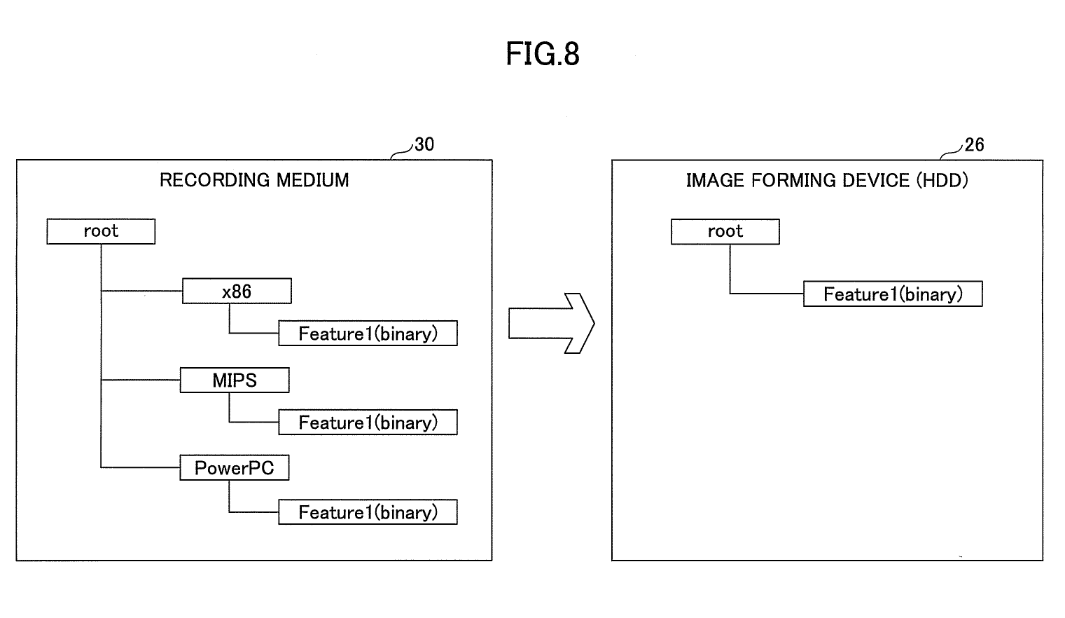

FIG. 8 is a diagram for explaining a tree structure of directories of a sales package. The tree structure on the left-hand side of FIG. 8 expresses a tree structure of the storage locations of files stored within the sales package (the recording medium 30). The tree structure of the right-hand side of FIG. 8 expresses a tree structure of the storage location of a file stored in the HDD 26 of the image forming device 100 after installation.

For example, the sales package (the recording medium 30) provides a directory “x86” for x86 CPUs under a root directory and stores a compiled file for x86 CPUs “Feature 1 (native program)” in the directory “x86”. Similarly, the sales package (the recording medium 30) stores a compiled file for MIPS CPUs “Feature 1 (native program)” in a directory “MIPS”. The sales package (the recording medium 30) stores a compiled file for Power PC “Feature 1 (native program)” in a directory “Power PC”.

The program selection unit 114 selects, from the contents of the association file 121, a directory associated with the hardware information acquired by the hardware information acquisition unit 112 and the software information acquired by the software information acquisition unit 113. In a case of the example of FIG. 8, one of the three directories in which the “Feature 1” is stored respectively is selected by the program selection unit 114. Thereby, the storage location designation unit 115 can store the “Feature 1” of the selected directory into the HDD (for example, a root directory) of the image forming device 100.

As illustrated in FIG. 6, the functional update package 102 contains the association file 121, the common program (jar file) 122, the manifesto file, and the native programs 124 (native program-1, native program-2).

As described above, in the jar file 101 for installation, the program for update of the installation unit 111, the information for checking the need for acquisition of the hardware information, and the information for checking the need for acquisition of the software information are stored. In the above example, the execution file (jar file) of the Java programming language is described. Alternatively, an execution file of another programming language (for example, C#) may be used for allowing a virtual machine to operate on the platform.

In the association file 121, the information (a conversion table) indicating a storage location (which is associated with the hardware information and the software information) at which a native program 124 optimal for the image forming device 100 is stored is registered. Alternatively, in the association file 121, keyword information of the file (native program) associated with certain hardware information may be associated. Alternatively, a file name (path information) which contains a directory associated with the hardware information or the software information may be described in the conversion table of the association file 121.

In a system-independent programming language (for example, Java), a plug-in program may be added using the OSGi (Open Services Gateway Initiative) framework. The OSGi framework is a platform which manages a dynamic addition and execution of a Java program on a virtual machine. There are two modes: the mode in which the plug-in program is executed on a virtual machine, and the mode in which the plug-in program is executed on the OSGi framework. When the plug-in program is executed on the OSGi framework, two or more class files and resource files are archived for a jar file (bundle file). Apart from the mode in which the plug-in program is executed on the virtual machine, the manifesto file 123 (including attributes specific to the specifications of the OSGi) is needed.

For this reason, when the OSGi framework is used for the addition of a function by the plug-in, the contents of the association file 121 may be described in the manifesto file 123. It is necessary that the association file 121 contains at least information of the directory within the sales package at which the native program 124 associated with the hardware information and the software information is stored.

The common program (jar file) 122 is a program which is executable on the virtual machine by the image forming device 100 of any model. The “native program 1” 124 and the “native program 2” 124 are plural files having a same file name which are prepared when different programs of binary codes must be prepared in accordance with the hardware information or the software information. These files having the same file name are stored in different directories of the memory device respectively.

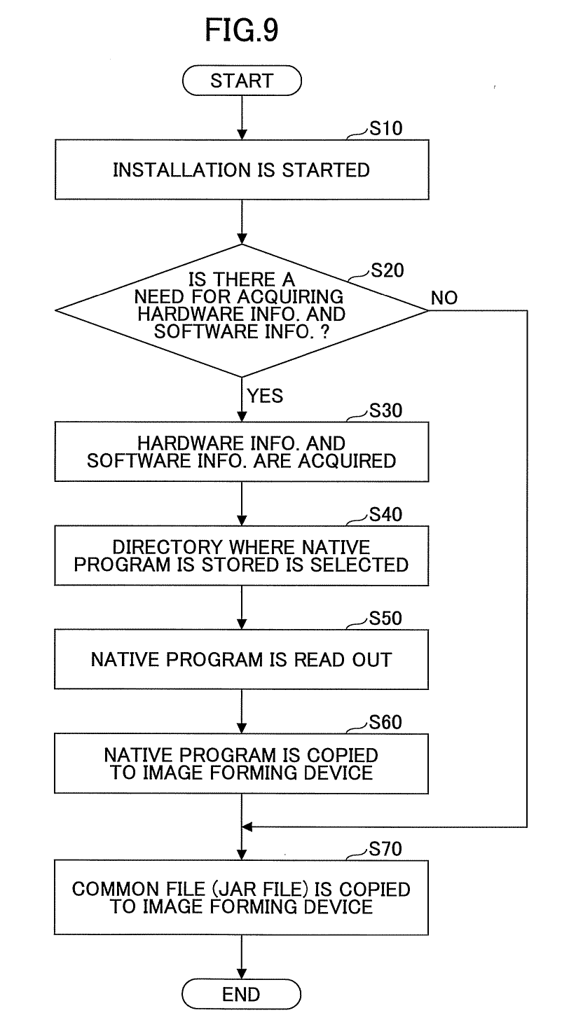

FIG. 9 is a flowchart for explaining the installing procedure performed by the installation unit 110 to install the functional update package 102 in the image forming device 100 of this embodiment.

As illustrated in FIG. 9, the installation unit 110 starts installation of the functional update package 102 in the image forming device 100 (S10). The installation is started when one of the following cases takes place. The cases include a case in which an operation input by the user is received by the image forming device 100, a case in which a request of automatic updating of the functional update package 102 is sent due to timeout by the timer or calendar, and a case in which a functional addition request from the server 300 is received by the image forming device 100. Upon start of the installation, the CPU 24 executes the jar file 101 for installation and initiates the judgment unit 111 and other units.

Subsequently, the judgment unit 111 determines whether there is a need to acquire the hardware information or the software information (S20).

When the judgment unit 111 determines in step S20 that there is the need to acquire the hardware information, the hardware information acquisition unit 112 acquires the hardware information. When the judgment unit 111 determines in step S20 that there is the need to acquire the software information, the software information acquisition unit 113 acquires the software information (S30).

When the judgment unit 111 determines in step S20 that there is no need to acquire the hardware information or the software information the judgment unit 111, the storage location designation unit 115 installs the common program (jar file) 122 (S70).

Subsequently, the program selection unit 114 accesses the association file 121 or the manifesto file 123 included in the functional update package 102 based on the hardware information and the software information, and selects the directory of the product in which the native program 124 to be installed is stored (S40).

Subsequently, the storage location designation unit 115 reads out the native program 124 from the storage unit 30 or the storage location in the directory of the recording medium 30 where the native program 124 is stored (S50).

Subsequently, the storage location designation unit 115 copies the native program 124 to the designated storage location in the directory of the image forming device 100 (S60).

Subsequently, the storage location designation unit 115 copies the common program (jar file) 122 described in the system-independent programming language and being common to all of the models, to a designated storage location in the directory of the image forming device 100 (S70).

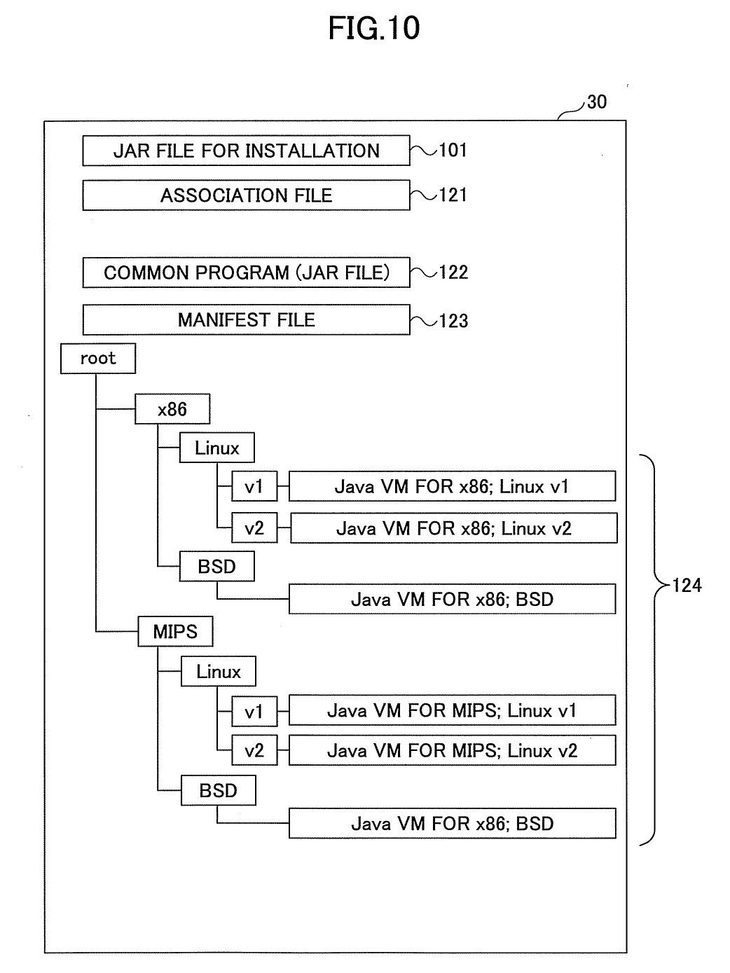

Next, FIG. 10 illustrates an example of a sales package which can be installed in both a previously marketed image forming device and a currently marketed image forming device. In the following, the exemplary cases in which the sales package of FIG. 10 is installed in a corresponding one of the image forming devices 1-4 of FIG. 4 will be described.

The need to upgrade a virtual machine of the image forming device may sometime arise. An example of the sales package for upgrading a virtual machine of the image forming device is illustrated in FIG. 10.

The reasons a virtual machine of the image forming device is upgraded after sale of the image forming device are as follows. One of the reasons is that the upgrading of the virtual machine is needed in order to eliminate a bug contained in the virtual machine or to add a new function (plug-in). Another reason is that the upgrading of the virtual machine is needed in order to stabilize operation of the image forming device after the sale of the image forming device. Still another reason is that the upgrading of the virtual machine is needed in order to increase the processing speed of a certain program of the image forming device.

First, the case in which the sales package of FIG. 10 is installed in the image forming device 1 will be described. If the sales package of FIG. 10 is supplied to the image forming device 1 through the recording medium 30 or through the network 600, the CPU 24 executes the jar file 101 for installation.

The jar file 101 for installation may be an installer of the virtual machine after the installation. A message indicating that installation of a function has been started may be displayed on the operation unit 14 or the display device of the PC 500 connected via the network 600.

Subsequently, the judgment unit 111 accesses the jar file 101 for installation and determines that there is a need to acquire the hardware information. The hardware information acquisition unit 112 accesses and acquires the hardware information of the image forming device 1.

The hardware information acquisition unit 112 may access the ID register of the CPU 24 and acquire the hardware information. The hardware information acquisition unit 112 may read information, such as a CPU type stored in the non-volatile memory, to acquire the hardware information. In the case of the image forming device 1, the hardware information acquired is “CPU: x86”. The hardware information acquisition unit 112 transfers the acquired hardware information to the program selection unit 114.

Subsequently, the judgment unit 111 determines that there is a need to acquire the software information. The software information acquisition unit 113 acquires the software information of the image forming device 1.

The software information is usually stored in the non-volatile memory and contains information, such as an OS type, an OS version, a version of a library file, etc. It is assumed that the software information acquisition unit 113 acquires at least the OS type and the OS version.

In the case of the image forming device 1, the software information acquired is “OS: BSD version 1”. The software information acquisition unit 113 transfers the acquired software information to the program selection unit 114.

The program selection unit 114 accesses the association file 121 by using, as the key, “CPU: x86” and “OS: BSD version 1” acquired from the hardware information acquisition unit 112 and the software information acquisition unit 113 respectively.

In the association file 121, at least a directory in which the optimal native program 124 in conformity with the combination of the CPU type, the OS type and the OS version is stored is registered. Alternatively, in the association file 121, at least the information that allows the program selection unit 114 to access the directory may be described.

As illustrated in FIG. 10, the program selection unit 114 accesses the association file 121 and identifies the native program 124 “Java VM” stored in the directory “root¥x86¥BSD¥v1” as being the program to be installed. The program selection unit 114 transfers the information “root¥x86¥BSD¥v1” to the storage location designation unit 115.

The storage location designation unit 115 copies a file of the native program 124 for “x86 BSD version 1” stored in the directory of the received information to a temporary directory used for installation, and performs the copying of the program file to the image forming device 1. This is performed in order to allow the recovering measure to be taken when the original native program 124 is corrupted during installation.

In this manner, the installation unit 110 installs the sales package in the image forming device 1. It is possible to carry out the upgrading of a function of all the models including the previously marketed model by using a single sales package. Thereby, it is possible to provide the user or the customer with a common package of plug-in programs allowing two or more products to operate normally by making use of application programs that are not dependent on the hardware or the software, even when the products are of different models or of different versions.

In the above example, the upgrading of a virtual machine is performed. Alternatively, the upgrading or addition of a native program 124 may be performed similarly.

Next, the case in which the sales package of FIG. 10 is installed in the image forming device 2 will be described.

If the sales package of FIG. 10 is supplied to the image forming device 2 through the recording medium 30 or through the network 600, the judgment unit 111 executes the jar file 101 for installation. The judgment unit 111 accesses the jar file 101 for installation and determines that there is a need to acquire the hardware information. The hardware information acquisition unit 112 accesses and acquires the hardware information of the image forming device 2.

The hardware information acquisition unit 112 may access the ID register of the CPU 24 and acquire the hardware information. The hardware information acquisition unit 112 may read information, such as a CPU type stored in the non-volatile memory, to acquire the hardware information. In the case of the image forming device 2, the hardware information acquired is “CPU: x86”. The hardware information acquisition unit 112 transfers the acquired hardware information to the program selection unit 114.

Subsequently, the judgment unit 111 determines that there is a need to acquire the software information. The software information acquisition unit 113 acquires the software information of the image forming device 2.

The software information is usually stored in the non-volatile memory and contains information, such as an OS type, an OS version, a version of a library file, etc. It is assumed that the software information acquisition unit 113 acquires at least the OS type and the OS version.

In the case of the image forming device 2, the software information acquired is “OS: LINUX version 1”. The software information acquisition unit 113 transfers the acquired software information to the program selection unit 114.

The program selection unit 114 accesses the association file 121 by using, as the key, “CPU: x86” and “OS: LINUX version 1” acquired from the hardware information acquisition unit 112 and the software information acquisition unit 113 respectively.

In the association file 121, at least a directory in which the optimal native program 124 in conformity with the combination of the CPU type, the

OS type and the OS version the directory where program 124 is stored, is registered. Alternatively, in the association file 121, at least the information that allows the program selection unit 114 to access the directory may be described.

As illustrated in FIG. 10, the program selection unit 114 accesses the association file 121 and identifies the native program 124 “Java VM” stored in the directory “root¥x86¥Linux¥v1” as being the program to be installed. The program selection unit 114 transfers the information “root¥x86¥Linux¥v1” to the storage location designation unit 115.

The storage location designation unit 115 copies a file of the native program 124 for “x86 LINUX version 1” stored in the directory of the received information to a temporary directory used for installation, and performs the copying of the program file to the image forming device 2. This is performed in order to allow the recovering measure to be taken when the original native program 124 is corrupted during installation.

Next, the case in which the sales package of FIG. 10 is installed in the image forming device 3 will be described.

If the sales package of FIG. 10 is supplied to the image forming device 3 through the recording medium 30 or through the network 600, the judgment unit 111 executes the jar file 101 for installation.

The judgment unit 111 accesses the jar file 101 for installation and determines that there is a need to acquire the hardware information. The hardware information acquisition unit 112 accesses and acquires the hardware information of the image forming device 3.

The hardware information acquisition unit 112 may access the ID register of the CPU 24 and acquire the hardware information. The hardware information acquisition unit 112 may read information, such as a CPU type stored in the non-volatile memory, to acquire the hardware information. In the case of the image forming device 3, the hardware information acquired is “CPU: MIPS”. The hardware information acquisition unit 112 transmits the acquired hardware information to the program selection unit 114.

Subsequently, the judgment unit 111 determines that there is a need to acquire the software information. The software information acquisition unit 113 acquires the software information of the image forming device 3.

The software information is usually stored in the non-volatile memory and contains information, such as an OS type, an OS version, a version of a library file, etc. It is assumed that the software information acquisition unit 113 acquires at least the OS type and the OS version.

In the case of the image forming device 3, the software information acquired is “OS: LINUX version 1”. The software information acquisition unit 113 transfers the acquired software information to the program selection unit 114.

The program selection unit 114 accesses the association file 121 by using, as the key, “CPU: MIPS” and “OS: LINUX version 1” acquired from the hardware information acquisition unit 112 and the software information acquisition unit 113, respectively.

In the association file 121, at least a directory in which the optimal native program 124 in conformity with the combination of the CPU type, the OS type and the OS version is stored, is registered. Alternatively, in the association file 121, at least the information that allows the program selection unit 114 to access the directory may be described.

As illustrated in FIG. 10, the program selection unit 114 accesses the association file 121 and identifies the native program 124 “Java VM” stored in the directory “root¥MIPS¥Linux¥v1” as being the program to be installed. The program selection unit 114 transfers the information “root¥MIPS¥Linux¥v1” to the storage location designation unit 115.

The storage location designation unit 115 copies a file of the native program 124 for “MIPS LINUX version 1” stored in the directory of the received information to a temporary directory used for installation, and performs the copying of the program file to the image forming device 3. This is performed in order to allow the recovering measure to be taken when the original native program 124 is corrupted during installation.

Finally, the case in which the sales package of FIG. 10 is installed in the image forming device 4 will be described.

If the sales package of FIG. 10 is supplied to the image forming device 4 through the recording medium 30 or through the network 600, the judgment unit 111 executes the jar file 101 for installation.

The judgment unit 111 accesses the jar file 101 for installation and determines that there is a need to acquire the hardware information. The hardware information acquisition unit 112 accesses and acquires the hardware information of the image forming device 4.

The hardware information acquisition unit 112 may access the ID register of the CPU 24 and acquire the hardware information. The hardware information acquisition unit 112 may read information, such as a CPU type stored in the non-volatile memory, to acquire the hardware information. In the case of the image forming device 4, the hardware information acquired is “CPU: MIPS”. The hardware information acquisition unit 112 transmits the acquired hardware information to the program selection unit 114.

Subsequently, the judgment unit 111 determines that there is a need to acquire the software information. The software information acquisition unit 113 accesses and acquires the software information of the image forming device 4.

The software information is usually stored in the non-volatile memory and contains information, such as an OS type, an OS version, a version of a library file, etc. It is assumed that the software information acquisition unit 113 acquires at least the OS type and the OS version.

In the case of the image forming device 4, the software information acquired is “OS: LINUX version 2”. The software information acquisition unit 113 transfers the acquired software information to the program selection unit 114.

The program selection unit 114 accesses the association file 121 by using, as the key, “CPU: MIPS” and “OS: LINUX version 2” acquired from the hardware information acquisition unit 112 and the software information acquisition unit 113 respectively.

In the association file 121, at least, a directory in which the optimal native program 124 in conformity with the combination of the CPU type, the OS type and the OS version is stored is registered. Alternatively, in the association file 121, at least the information that allows the program selection unit 114 to access the directory may be described.

As illustrated in FIG. 10, the program selection unit 114 accesses the association file 121 and identifies the native program 124 “Java VM” stored in the directory “root¥MIPS¥Linux¥v2” as being the program to be installed. The program selection unit 114 transfers the information “root¥MIPS¥Linux¥v2” to the storage location designation unit 115.

The storage location designation unit 115 copies a file of the native program 124 for “MIPS LINUX version 2” stored in the directory of the received information to a temporary directory used for installation, and performs the copying of the program file to the image forming device 4. This is performed in order to allow the recovering measure to be taken when the original native program 124 is corrupted during installation.

Next, the case in which the sales package is used for an application program of the application group 31, and does not contain the native program 124, will be described.

When the sales package does not contain the native program 124, the image forming devices 1-4 can execute the application program on a virtual machine. Namely, all of the previously marketed image forming devices 1-3 and the latest type image forming device 4 can perform the application program on the virtual machine without depending on the CPU type, the OS type, the OS version, the version of the library file, etc.

First, the sales package of the application program is supplied to the image forming device 1 through the recording medium 30 or through the network 600. The judgment unit 111 executes the jar file 101 for installation. In this case, the judgment unit 111 determines that there is no need to acquire the hardware information, and acquisition of the hardware information by the hardware information acquisition unit 112 will be skipped. Moreover, the judgment unit 111 determines that there is no need to acquire the software information, and acquisition of the software information by the software information acquisition unit 113 will be skipped.

Subsequently, the hardware information and the software information are not notified, and the program selection unit 114 does not select the native program 124 for the image forming device 1. For this reason, the program selection unit 114 reads only the common program (jar file) 122 from the sales package, so that the common program 122 is installed in the image forming device 1.

Thus, use of a sales package that is not dependent on the hardware and the software makes the development of programs easy. The installation unit which is described in the system-independent programming language is configured to identify the native program 124 that is to be installed, among the native programs 124 for the models included in the sales package. Accordingly, the image-forming-device manufacturer can market a single sales package that is applicable to all the models.

As described in the foregoing, according to the present disclosure, it is possible to provide an image forming device, an installing method, and a recording medium which are capable of supplying a common package of plug-in programs allowing two or more products to operate normally by making use of application programs that are not dependent on the hardware or the software, even when the products are of different models or of different versions.

The present disclosure is not limited to the above-described embodiments, and variations and modifications may be made without departing from the scope of the present disclosure.

The present application is based on Japanese patent application No. 2009-208463, filed on Sep. 9, 2009, the contents of which are incorporated herein by reference in their entirety.

What is claimed is:

1. An image forming device including a processor unit comprising:
a package acquisition unit to acquire a program package through a recording medium or a network, the program package containing a program for installation, a first program and a second program, the program for installation described in a system-independent programming language that is executable without depending on execution environments, the first program described in a system-dependent programming language that is executed depending on a particular execution environment and registered for the particular execution environment, and the second program described in a system-independent programming language that is executable without depending on execution environments and registered commonly for execution environments;
an information acquisition unit to acquire information of an execution environment of the image forming device;
a program identifying unit to identify the first program which is executable in the execution environment of the image forming device, based on the information of the execution environment acquired by the information acquisition unit; and
a copy unit to copy the first program, identified by the program identifying unit, and the second program to a storage unit of the image forming device,
wherein the information acquisition unit, the program identifying unit, and the copy unit are installed in the image forming device by executing the program for installation.

2. The image forming device according to claim 1, wherein a plurality of the first programs with a same file name are associated with execution environments and registered in the program package.

3. The image forming device according to claim 1, wherein the program package contains an association file in which storage location information of the first program is associated with an execution environment and registered, and the program identifying unit acquires, from the association file, the storage location information of the first program associated with the execution environment the information of which is acquired by the information acquisition unit.

4. The image forming device according to claim 3, wherein the storage location information is directory information indicating a storage location of the first program in a tree-structured file system, and the program identifying unit identifies the first program that is executable in the image forming device, based on the directory information.

5. The image forming device according to claim 1, wherein the program package contains first program existence information which indicates whether the first program depending on an execution environment is included in the program package, and the image forming device further comprises a judgment unit to determine whether the information acquisition unit is made to acquire information of the execution environment of the image forming device, based on the first program existence information.

6. The image forming device according to claim 1, wherein, when the program for installation is executed, a message, indicating that installation of the first program or the second program is under execution, is displayed on a display unit of the image forming device.

7. The image forming device according to claim 1, wherein, when the program for installation is stored beforehand in a storage unit of the image forming device, the program for installation stored in the storage unit of the image forming device is replaced with the program for installation of the program package.

8. The image forming device according to claim 1, wherein the execution environment of the image forming device is defined by hardware information and software information of the image forming device.

9. The image forming device given in claim 8, wherein the hardware information contains one of a CPU name, a CPU type and a CPU model number, and the software information contains one of an OS name, an OS version and a version of a library file.

10. The image forming device according to claim 1, wherein the programming language that is executable without depending on execution environments is Java.

11. An installing method for use in an image forming device including a processor unit, comprising:
acquiring, by a package acquisition unit of the processor unit, a program package through a recording medium or a network, the program package containing a program for installation, a first program and a second program, the program for installation described in a system-independent programming language that is executable without depending on execution environments, the first program described in a system-dependent programming language that is executed depending on a particular execution environment and registered for the particular execution environment, and the second program described in a system-independent programming language that is executable without depending on execution environments and registered commonly for execution environments;
acquiring, by an information acquisition unit of the processor unit, information of an execution environment of the image forming device;
identifying, by a program identifying unit of the processor unit, the first program which is executable in the execution environment of the image forming device, based on the acquired information of the execution environment; and
copying, by a copy unit of the processor unit, the identified first program and the second program to a storage unit of the image forming device,
wherein the information acquisition unit, the program identifying unit, and the copy unit are installed in the image forming device by executing the program for installation.

12. A computer-readable recording medium storing a program which, when executed by a computer, causes the computer to perform an installing method for use in an image forming device including a processor unit, the installing method comprising:
acquiring, by a package acquisition unit of the processor unit, a program package through a recording medium or a network, the program package containing a program for installation, a first program and a second program, the program for installation described in a system-independent programming language that is executable without depending on execution environments, the first program described in a system-dependent programming language that is executed depending on a particular execution environment and registered for the particular execution environment, and the second program described in a system-independent programming language that is executable without depending on execution environments and registered commonly for execution environments;
acquiring, by an information acquisition unit of the processor unit, information of an execution environment of the image forming device;
identifying, by a program identifying unit of the processor unit, the first program which is executable in the execution environment of the image forming device, based on the acquired information of the execution environment; and
copying, by a copy unit of the processor unit, the identified first program and the second program to a storage unit of the image forming device,
wherein the information acquisition unit, the program identifying unit, and the copy unit are installed in the image forming device by executing the program for installation.
